(19) United States
(12) Patent Application Publication
(10) Pub. No.: US 2013/0238213 A1
(43) Pub. Date: Sep. 12, 2013

(54) FLYWHEEL DIAGNOSTIC SYSTEM AND METHOD

(71) Applicant: Jeffrey Edward Jensen, Dunlap, IL (US)

(72) Inventor: Jeffrey Edward Jensen, Dunlap, IL (US)

(73) Assignee: CATERPILLAR, INC., Peoria, IL (US)

(21) Appl. No.: 13/413,271

(22) Filed: Mar. 6, 2012

(51) Int. Cl. F01P 7/00; B60W 10/02; G01M 13/00

(52) U.S. Cl. 701/99; 477/174

(57) ABSTRACT

Flywheel diagnostic systems and methods may be advantageously employed on machines having flywheel assemblies to preserve the integrity of the flywheel and/or related components in the event of a malfunction. Feedback regarding flywheel or machine operating parameters may be used to determine the possibility of a malfunction. Remedial actions may be taken in response to the indication of a possible malfunction. For example, a cooling system may be operated to reduce the temperature of the flywheel, thereby to preserve flywheel integrity. Additionally or alternatively, the flywheel may be coupled to a CVT to actively slow flywheel rotation. For other malfunctions, the flywheel may be disengaged from the CVT to prevent damage to flywheel components that may result from further overspeeding of the flywheel.

### TECHNICAL FIELD

The present disclosure generally relates to flywheel energy storage devices, and more particularly to systems and methods for performing diagnostics on flywheel energy storage devices.

### BACKGROUND

Flywheels are generally known in the art for storing energy. While flywheel energy storage devices have been used for many years in satellite or other spacecraft applications, more recently they have been adapted for use on terrestrial machines. More specifically, hybrid power plants have been proposed which use a combustion engine as the primary mover and a flywheel as a secondary mover.

In some applications, the flywheel is coupled to an engine by a continuously variable transmission (CVT), thereby to add or subtract power to that supplied by the engine to a driven pair of wheels. This arrangement may use regenerative braking, in which the flywheel is sped up to capture kinetic energy of the machine as it decelerates. Conversely, when the machine is accelerating, the flywheel may provide additional power to the wheels, thereby reducing flywheel speed.

In other applications, the flywheel is coupled to a powertrain by the CVT. When the machine decelerates, energy from the powertrain (and an associated transmission) is transferred to the flywheel. During acceleration of the machine, energy from the flywheel is transferred to the powertrain.

In such flywheel systems, the CVT ratio may be manipulated to control energy storage and recovery. For example, when the ratio is set to increase the speed of the flywheel, energy from the machine is stored in the flywheel. Conversely, when the ratio is set to decrease the speed of the flywheel, energy is recovered from the flywheel for use by the machine.

Specialized flywheel materials have been developed to improve the efficiency of the flywheel energy storage devices. Conventional flywheels were made of metals, such as iron or steel. The relatively high density of these materials, however, limited the speed at which metal flywheels could be rotated before becoming structurally unstable. More recently, flywheels have been made of carbon fiber material having a strength-to-weight ratio that is higher than the metal materials, thereby permitting rotation at higher speeds, such as up to approximately 60,000 rpm or more, thereby increasing energy storage capacity. The higher rotational speeds, however, often necessitate the use of specialized high speed bearings to journally support the flywheel.

The efficiency of a flywheel energy storage device is further impacted by friction forces that resist rotation of the flywheel. To reduce friction, the flywheel is often located in a housing that is maintained at a partial vacuum pressure (i.e., substantially below atmospheric pressure for terrestrial applications). A vacuum pump is typically coupled to the housing to generate the desired partial vacuum in the housing.

Due to the high rotational speeds of the flywheel, as well as the specialized components and environment needed for efficient operation, slight changes in operating conditions may quickly lead to potentially catastrophic damage. For example, the carbon fiber material used in some flywheels may delaminate and disintegrate when housing temperatures exceed approximately 170° C. The housing may reach such temperatures when one or more components do not operate properly, such as when the housing pressure is elevated due to a housing leak or malfunctioning vacuum pump. Flywheels made of carbon fiber material are very expensive, and therefore such a failure may be extremely costly to replace. Additionally, failure of the flywheel may degrade drivetrain performance.

U.S. Pat. No. 6,144,128 to Rosen proposes a safety system for a flywheel energy storage device provided on a machine. The flywheel is disposed in a vacuum housing, and an outer housing encloses the vacuum housing and is sized to form a gap between the outer housing and the vacuum housing. The gap is filled with a liquid that primarily provides buoyancy to the vacuum housing and damps potentially damaging movements of the vacuum housing. The liquid may be cooled, such as by a radiator, and pumped through the gap to also cool the vacuum housing. According to Rosen, the liquid is continuously pumped through the gap, but flow may be briefly interrupted when the machine negotiates sharp turns.

### SUMMARY OF THE DISCLOSURE

In accordance with one aspect of the disclosure, a flywheel diagnostic system is provided for a machine having an engine and a ground engaging member. The flywheel diagnostic system includes a flywheel assembly having a flywheel housing and an energy storage flywheel rotationally mounted in the flywheel housing and operably coupled to the ground engaging member. A feedback sensor is associated with the flywheel assembly and operable to sense an operational parameter of the energy storage flywheel and supply a sensor signal indicative of the operational parameter. A controller is operatively coupled to the feedback sensor and configured to generate a flywheel fault signal when the sensor signal deviates from an acceptable parameter value. A cooling system is thermally coupled to the flywheel assembly and operable, in response to the flywheel fault signal, to supply a cooled fluid to the flywheel assembly.

In another aspect of the disclosure that may be combined with any of these aspects, a method is provided of performing flywheel diagnostics on a machine having an engine and a ground engaging member. The method includes providing a flywheel assembly having a flywheel housing and an energy storage flywheel rotationally mounted in the flywheel housing and operably coupled to the ground engaging member, determining a flywheel parameter associated with the flywheel assembly, determining a flywheel fault condition when the flywheel parameter deviates from an acceptable parameter value, and supplying a cooled fluid to the flywheel assembly in response to the flywheel fault condition.

In another aspect of the disclosure that may be combined with any of these aspects, a method is provided of performing flywheel diagnostics on a machine having an engine and a ground engaging member. The method includes providing a flywheel assembly having a flywheel housing and an energy storage flywheel rotationally mounted in the flywheel housing, providing a clutch configured to selectively transmit torque between the flywheel and the ground engaging member, the clutch being movable between an engaged position, in which the flywheel is rotatably coupled to the ground engaging member, and a disengaged position, in which the flywheel is decoupled from the ground engaging member, determining an expected flywheel rotational speed, determining an observed flywheel rotational speed, determining a flywheel fault condition when the observed flywheel rotational speed exceeds the expected flywheel rotational speed, and actuating the clutch to the disengaged position in response to the flywheel fault condition.

### BRIEF DESCRIPTION OF THE DRAWINGS

FIG. 1 is a schematic block diagram of a machine having a flywheel assembly with a flywheel diagnostic system according to an exemplary disclosed embodiment.

FIG. 2 is a schematic block diagram of a machine having a flywheel energy storage system with a flywheel diagnostic system according to another exemplary disclosed embodiment.

FIG. 3 is a schematic side elevation view, in cross-section, of the flywheel assembly provided on the machine of FIG. 1.

FIG. 4 is a flowchart illustrating a diagnostic routine that may be implemented by the flywheel diagnostic systems.

FIG. 5 is a flowchart illustrating an alternative diagnostic routine that may be implemented by the flywheel diagnostic systems.

### DETAILED DESCRIPTION

Embodiments of a flywheel diagnostic system and method are disclosed for use in a flywheel energy storage system provided on a machine. The flywheel diagnostic system includes one or more feedback sensors for monitoring an operating parameter of the flywheel energy storage system. A controller is operably coupled to the feedback sensor(s) and may initiate one or more remedial actions in response to a sensed parameter outside of a predetermined range, or a rate of change above a predetermined limit. For example, a cooling system may be thermally coupled to a housing for the flywheel, wherein the controller initiates operation of the cooling system in response to the feedback signal. Additionally or alternatively, the controller may disengage a flywheel clutch in response to a sensed parameter outside of range. The remedial actions are intended to prevent or limit damage to the flywheel and/or associated components.

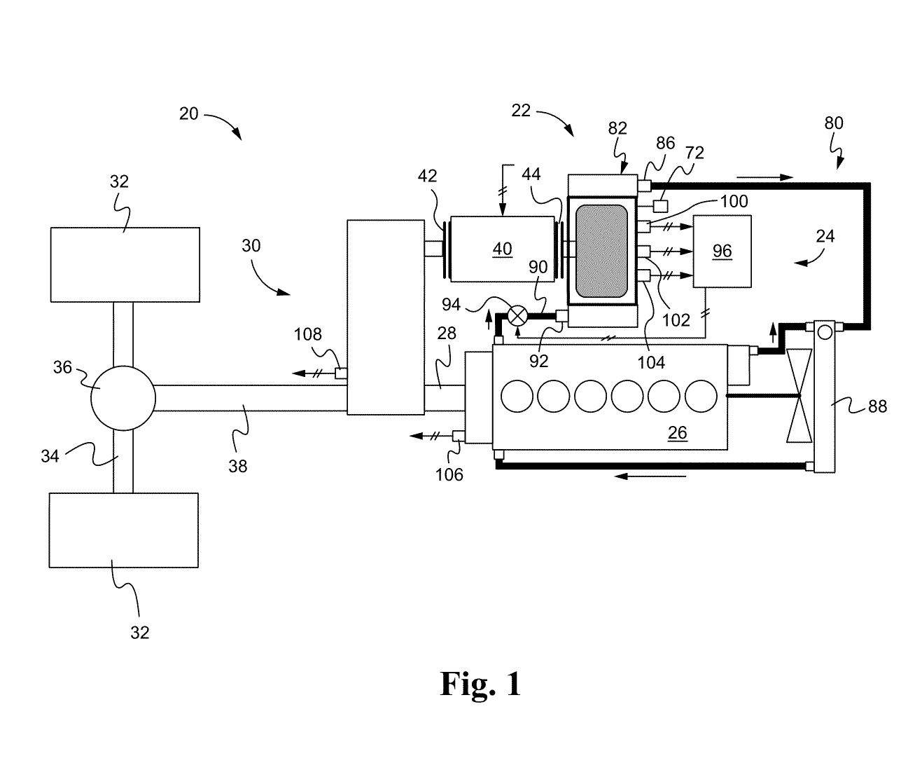

FIG. 1 illustrates an exemplary embodiment of a machine 20 having a flywheel assembly 22 with a flywheel diagnostic system 24 as disclosed herein. The machine 20 includes an engine 26 having a crankshaft 28 and a drivetrain 30 operably coupled to the crankshaft 28.

The engine 26 may be any type of engine (internal combustion, gas, diesel, gaseous fuel, natural gas, propane, etc.), may be of any size, with any number of cylinders, and in any configuration (“V,” in-line, radial, etc.). The engine 26 may be used to power any machine or other device, including on-highway trucks or vehicles, off-highway trucks or machines, earth moving equipment, generators, aerospace applications, locomotive applications, marine applications, pumps, stationary equipment, or other engine powered applications.

The drivetrain 30 transmits torque generated by the engine 26 and output by the crankshaft 28 to ground engaging members. In the illustrated embodiment, the ground engaging members include a pair of rear wheels 32. The rear wheels 32 may be spaced from a plurality of front wheels (not shown) and disposed in pairs along opposite sides of the machine 20; however it will be appreciated that the ground engaging members may include alternate arrangements. Ground engaging members may include tires, tracks, and the like that may be suitable for a particular application and in a way that may be adaptable for use with aspects of the present disclosure. The drivetrain 30 may include an axle 34 coupled to the wheels 32, a differential 36 operatively coupled to the axle 34, and a drive shaft 38 operatively coupled to the differential 36. The drivetrain 30 may further include a transmission, a torque converter, additional drive shafts and associated gears, clutches, and/or additional components commonly used to transmit torque from an engine to ground engaging members.

The flywheel assembly 22 may be operably coupled to the drivetrain 30 to store energy from or discharge energy to the machine 20. In the exemplary embodiment illustrated in FIG. 1, a continuously variable transmission (CVT) 40 is provided between the flywheel assembly 22 and the drivetrain 30. A first CVT clutch 42 is provided to selectively engage the CVT 40 with the drivetrain 30, while a second CVT clutch 44 is provided to selectively engage the CVT 40 with the flywheel assembly 22. The CVT 40 may operably engage the flywheel assembly 22 with the drive shaft 38, the differential 36, the transmission, or any other suitable component of the drivetrain 30.

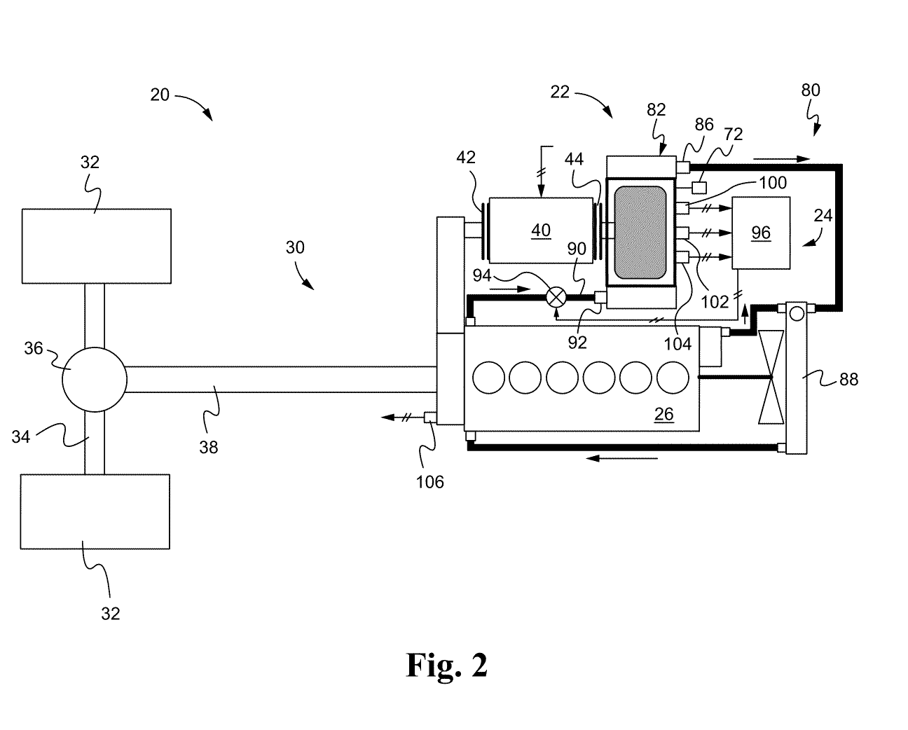

In an alternative embodiment illustrated in FIG. 2, the flywheel assembly 22 may be directly connected to the drive shaft 38 instead of through a transmission or other similar component of the drivetrain 30.

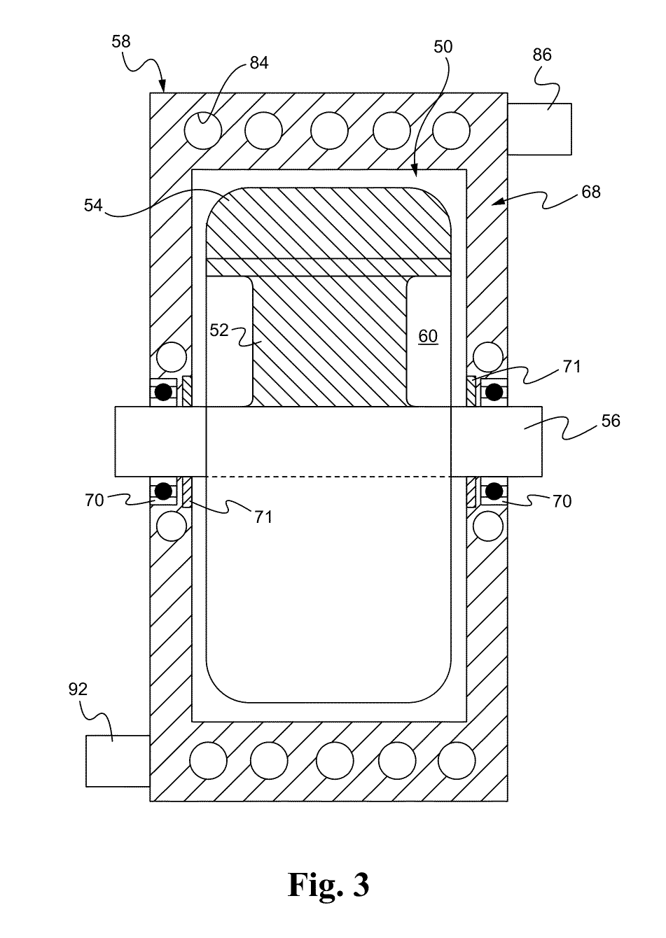

As best shown in FIG. 3, the flywheel assembly 22 may include an energy storage flywheel 50 having a hub 52 and a rim 54. The hub 52 may be formed of a material, such as aluminum or steel, which is suitable for supporting the mass of the rim 54 when the flywheel 50 rotates at speeds of up to 60,000 rpm or more. The rim 54 may be formed of any suitable flywheel material, such as iron, steel, or carbon fiber. A rotatable shaft 56 is coupled to the hub 52. As schematically illustrated in FIG. 1, one end of the shaft 56 may be configured for selective engagement by the second CVT clutch 44.

A housing 58 defines a chamber 60 sized to receive the flywheel 50. Bearings 70 are coupled to opposite sides of the housing 58 and journally support respective portions of the rotatable shaft 56. Two shaft seals 71 are provided, wherein each shaft seal 71 is disposed between the housing 58 and a respective end of the shaft 56 to provide an air tight seal therebetween. A vacuum pump 72 fluidly communicates with the chamber 60 to generate a partial vacuum inside the housing 58.

A cooling system 80 is thermally coupled to the flywheel assembly 22 to provide selective cooling to the chamber 60. The cooling system 80 may include a cooling jacket 82 in thermal contact with the flywheel assembly 22 and configured to use cooled fluid to draw heat from the chamber 60, thereby to cool the flywheel 50. As best shown in FIGS. 1 and 3, the cooling jacket 82 is provided by a helical conduit 84 formed in the housing 58. A conduit outlet 86 fluidly communicates with a heat exchanger, such as a radiator 88 provided with an existing engine cooling system, that is configured to reject heat from the fluid into the surrounding environment. An inlet branch 90 is disposed between the radiator 88 and a conduit inlet 92 leading to the helical conduit 84 for directing cooled fluid into the cooling jacket 82. A cooling system valve 94 is disposed in the inlet branch 90 to regulate flow of cooled fluid into the helical conduit 84.

A controller, such as electronic control module (ECM) 96, is provided to control operation of components provided on the machine 20. For example, the ECM 96 may be operably coupled to the engine 26, CVT 40, first and second CVT clutches 42, 44, and cooling system valve 94 to control operation of these components based on user inputs or feedback regarding operating parameters. The ECM 96 may include any components that may be used to run an application such as, for example, a memory, a secondary storage device, and a central processing unit. The ECM 96 may, however, contain additional or different components such as, for example, mechanical or hydromechanical devices. Various other known circuits may be associated with the ECM 96 such as, for example, power supply circuitry, signal-conditioning circuitry, solenoid driver circuitry, and other appropriate circuitry. While the ECM 96 is depicted in the drawings as a single controller, connected, multiple controllers may be used.

The flywheel diagnostic system 24 includes one or more feedback sensors for monitoring an operating parameter of the flywheel assembly 22. The feedback sensor is operable to sense an operational parameter of the flywheel assembly 22 and supply a sensor signal indicative of the operational parameter. For example, a flywheel speed sensor 100 may be provided that is configured to sense a rotational speed of the flywheel 50 and generate a flywheel speed signal. Additionally or alternatively, a flywheel temperature sensor 102 may be provided that is configured to sense a temperature inside the flywheel housing 58 and generate a flywheel temperature signal. Stiller further, a flywheel chamber pressure sensor 104 may be provided that is configured to sense a pressure inside the flywheel housing 58 and generate a flywheel housing pressure signal.

The flywheel diagnostic system 24 may also include feedback sensors associated with other components of the machine 20 that may be used for diagnostic purposes. For example, an engine speed sensor 106 may be provided that is configured to sense an engine speed and generate an engine speed signal. Additionally or alternatively, a drivetrain speed sensor 108 may be provided that is configured to sense a rotational speed of a drivetrain component and generate a drivetrain speed signal. Still further, the command signal to the CVT 40 may be monitored to provide diagnostic feedback. The CVT command signal, in combination with at least one of the drivetrain speed signal and the engine speed signal, can be used to determine an expected rotational speed of the flywheel 50.

The ECM 96 may be configured to generate a fault signal when the signal deviates from an acceptable value. Depending on which parameter the feedback is based on and how that feedback is deviating from the accepted value, the ECM 96 may initiate different actions in response to the flywheel fault signal.

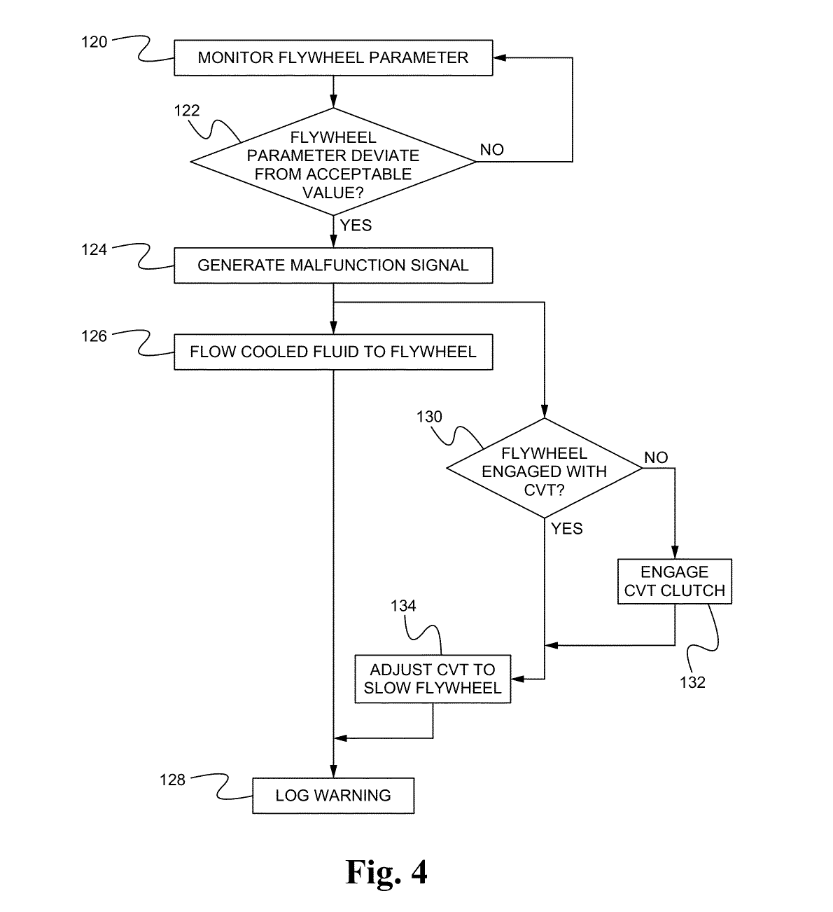

Some operating conditions may indicate a first type of flywheel malfunction that is non-destructive, temporary, or otherwise not immediately threatening to the integrity of the flywheel 50. In response to this first type of malfunction, the ECM 96 may initiate actions intended to preserve the integrity of the flywheel 50. As illustrated by the flowchart of FIG. 4, this first type of malfunction detection may begin at block 120 by monitoring an observed value of one or more flywheel parameters. The flywheel parameter may be the flywheel temperature, pressure, or speed as indicated by the associated sensors.

At block 122, The ECM 96 may determine whether the observed flywheel parameter value deviates from an accepted flywheel parameter value. For example, if the flywheel parameter is the flywheel temperature, then the ECM 96 may determine if the observed flywheel temperature exceeds an upper flywheel temperature limit. The upper flywheel temperature limit may be set at a temperature that is below a critical flywheel temperature at which the flywheel 50 is susceptible to delaminating or other damage, such as 170° C.

Alternatively, if the flywheel parameter is the observed flywheel chamber pressure, then the ECM 96 may determine if the observed flywheel chamber pressure exceeds an upper flywheel chamber pressure limit. An increased chamber pressure may indicate that the chamber 60 is leaking to atmosphere through the housing 58, bearings, or other flywheel assembly component, or that the vacuum pump 72 is malfunctioning.

Still further, if the flywheel parameter is the observed flywheel rotational speed, then the ECM 96 may determine if the observed flywheel rotational speed is less than an expected flywheel rotational speed. As noted above, the expected flywheel rotation speed may be determined from the command signal to the CVT 40 and at least one of the drivetrain speed and the engine speed. An observed flywheel speed below the expected flywheel speed may indicate that the force required to rotate the flywheel 50 has increased. A higher force required to rotate the flywheel 50 may be caused by an increase in chamber pressure causing excessive friction acting against the rotation of the flywheel 50, a bearing failure, or other malfunctioning component of the flywheel assembly 22.

Additionally or alternatively, the accepted flywheel parameter value may be a rate of change of the observed flywheel parameter. Instead of using an upper or lower parameter limit to quantify when a malfunction is occurring, the ECM 96 may monitor a rate of change of the parameter. Accordingly, at block 122, the ECM 96 may determine whether an observed rate of change of the parameter exceeds a predetermined parameter rate of change limit.

If the observed parameter value does not deviate from the acceptable parameter value, then the process returns to block 120 to continue monitoring the selected parameter(s). Otherwise, if the observed parameter value deviates from the acceptable parameter value, then the ECM 96 may signal a possible flywheel malfunction at block 124.

If a possible malfunction is determined to be present, the process may advance to block 126 where the ECM 96 may send a flywheel fault signal to the cooling system 80. The cooling system 80 may be responsive to the flywheel fault signal to send cooled fluid through the cooling jacket 82, such as by opening the cooling system valve 94. Reducing the temperature inside the chamber 60 may prevent deterioration of the flywheel 50 due to excessive heat. In addition, at block 128, the ECM 96 may log a fault warning.

In certain applications, it may be desirable to initiate an additional or alternative action in response to the flywheel fault signal. For example, when the observed flywheel speed is less than the expected flywheel speed, the possible causes for the lower observed speed generally will not be exacerbated by continued connection of the flywheel 50 to the drive shaft 38. Accordingly, rotation of the flywheel 50 can be stopped more quickly by maintaining engagement of the flywheel 50 and drive shaft 38.

Accordingly, in response to the flywheel fault signal generated at block 126, the process may additionally proceed to block 130 where the ECM 96 determines whether the second CVT clutch 44 is engaged, as shown in FIG. 4. If the clutch 44 is not engaged, the process continues to block 132 where the ECM 96 actuates the second CVT clutch 44 to the engaged position. Next, at block 134, the ECM 96 adjusts the CVT 40 to actively slow rotation of the flywheel 50. As a result, the flywheel 50 may be more quickly stopped or reduced to a speed that lowers the risk of damage to the flywheel 50.

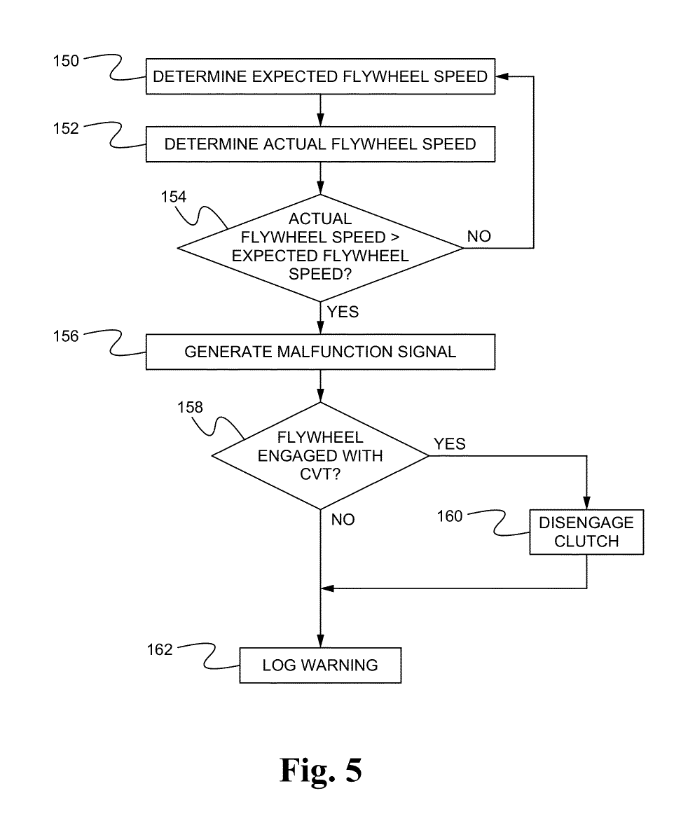

Other operating conditions may indicate a second type of malfunction that is destructive, permanent, or otherwise significantly threatens the integrity of the flywheel 50. In response to this second type of malfunction, the ECM 96 may initiate actions to minimize damage to the flywheel assembly 22 and/or surrounding environment. The flowchart of FIG. 5 shows an exemplary process for detecting this second type of malfunction. The process begins at block 150, where the ECM 96 may determine an expected flywheel speed. As noted above, the expected flywheel speed may be determined based on the CVT command and at least one of the engine speed and drivetrain speed. Furthermore, the expected flywheel speed may be set at an increased value to accommodate normal fluctuations of rotational speed during flywheel operation. Next, at block 152, the ECM 96 determines an actual rotational speed of the flywheel.

At block 154, the ECM 96 determines whether the actual flywheel speed exceeds the expected flywheel speed. If the actual flywheel speed does not exceed the expected flywheel speed, the process returns to block 150 to determine the expected flywheel speed. Otherwise, if the actual flywheel speeds exceeds the expected flywheel speed, at block 156 the ECM 96 may signal a possible flywheel malfunction.

An actual speed that exceeds the expected speed may be indicative of a loss of mass from the flywheel 50, which may in turn indicate that the flywheel 50 is delaminating or otherwise disintegrating. Accordingly, in response to the malfunction signal, the process may proceed to block 158 in which the ECM 96 determines whether the second CVT clutch 44 is engaged. If the clutch 44 is engaged, the process proceeds to block 160, where the ECM 96 actuates the second CVT clutch 44 to the disengaged position to prevent further overspeeding of the flywheel 50. In addition, at block 162, the ECM 96 may log a fault warning.

### INDUSTRIAL APPLICABILITY

The foregoing flywheel diagnostic systems and methods may be advantageously employed on machines having flywheel assemblies to preserve the integrity of the flywheel and/or related components in the event of a malfunction. Feedback regarding flywheel or machine operating parameters may be used to determine the possibility of a malfunction. Depending on the type of feedback, the malfunction may be characterized as a first type of malfunction that may not immediately threaten the integrity of the flywheel, or a second type of malfunction that may indicate imminent or ongoing flywheel degradation. Remedial actions may be taken based on the classification of the malfunction. For the first type of malfunctions, a cooling system may be operated to reduce the temperature of the flywheel, thereby to preserve flywheel integrity. Additionally or alternatively, the flywheel may be coupled to the CVT to actively slow flywheel rotation. For the second type of malfunctions, the flywheel may be disengaged from the CVT to prevent damage to flywheel components and the surrounding environment that may result from further overspeeding of the flywheel.

It will be appreciated that the foregoing description provides examples of the disclosed assembly and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A flywheel diagnostic system for a machine having an engine and a ground engaging member, the flywheel diagnostic system comprising:
a flywheel assembly including:
a flywheel housing;
an energy storage flywheel rotationally mounted in the flywheel housing and operably coupled to the ground engaging member;
a feedback sensor associated with the flywheel assembly, the feedback sensor operable to sense an operational parameter of the energy storage flywheel and supply a sensor signal indicative of the operational parameter;
a controller operatively coupled to the feedback sensor and configured to generate a flywheel fault signal when the sensor signal deviates from an acceptable parameter value; and
a cooling system thermally coupled to the flywheel assembly and operable, in response to the flywheel fault signal, to supply a cooled fluid to the flywheel assembly.

2. The flywheel diagnostic system of claim 1, in which the controller is configured to generate the flywheel fault signal when the sensor signal crosses a parameter value limit.

3. The flywheel diagnostic system of claim 1, in which the controller is configured to generate the flywheel fault signal when the sensor signal crosses a parameter change rate limit.

4. The flywheel diagnostic system of claim 1, in which the feedback sensor is configured to sense a flywheel speed and generate a flywheel speed signal, and in which the controller is further configured to:
determine an expected flywheel speed; and
generate the flywheel fault signal when the flywheel speed signal is less than the expected flywheel speed.

5. The flywheel diagnostic system of claim 1, in which the feedback sensor is configured to sense a temperature inside the flywheel housing and generate a temperature signal, and in which the controller is further configured to generate the flywheel fault signal when the temperature signal exceeds an upper temperature limit.

6. The flywheel diagnostic system of claim 1, in which the feedback sensor is configured to sense a pressure inside the flywheel housing and generate a pressure signal, and in which the controller is further configured to generate the flywheel fault signal when the pressure signal exceeds an upper pressure limit.

7. The flywheel diagnostic system of claim 1, further comprising:
a second feedback sensor associated with the flywheel assembly, the second feedback sensor operable to sense a second operational parameter of the energy storage flywheel and supply a second sensor signal indicative of the second operational parameter;
in which the controller is operatively coupled to the second feedback sensor and further configured to generate the flywheel fault signal when both the sensor signal and the second sensor signal deviate from acceptable parameter values.

8. The flywheel diagnostic system of claim 7, in which the feedback sensor is configured to sense a temperature inside the flywheel housing and generate a temperature signal, the second feedback sensor is configured to sense a pressure inside the flywheel housing and generate a pressure signal, and the controller is configured to generate the flywheel fault signal when both the temperature signal exceeds a temperature limit and the pressure signal exceeds a pressure limit.

9. The flywheel diagnostic system of claim 1, further comprising a clutch operatively coupled to the controller and configured to selectively transmit torque between the flywheel and the ground engaging member, the clutch being movable between an engaged position, in which the flywheel is rotatably coupled to the ground engaging member, and a disengaged position, in which the flywheel is decoupled from the ground engaging member.

10. The flywheel diagnostic system of claim 9, in which the clutch is configured to actuate to the engaged position in response to the flywheel fault signal.

11. The flywheel diagnostic system of claim 1, in which the cooling system comprises a cooling jacket associated with the flywheel housing.

12. The flywheel diagnostic system of claim 11, in which the cooling system further comprises a radiator associated with the engine.

13. A method of performing flywheel diagnostics on a machine having an engine and a ground engaging member, the method comprising:
providing a flywheel assembly having a flywheel housing and an energy storage flywheel rotationally mounted in the flywheel housing and operably coupled to the ground engaging member;
determining a flywheel parameter associated with the flywheel assembly;
determining a flywheel fault condition when the flywheel parameter deviates from an acceptable parameter value; and
supplying a cooled fluid to the flywheel assembly in response to the flywheel fault condition.

14. The method of claim 13, in which determining the flywheel fault condition comprises determining when the flywheel parameter crosses a parameter value limit.

15. The method of claim 13, in which determining the flywheel fault condition comprises determining when the flywheel parameter crosses a parameter change rate limit.

16. The method of claim 13, in which the flywheel parameter comprises an observed flywheel speed, the acceptable parameter value comprises an expected flywheel speed, and determining the flywheel fault condition comprises determining when the observed flywheel speed deviates from the expected flywheel speed.

17. The method of claim 13, in which the flywheel parameter comprises a temperature inside the flywheel housing, and in which determining the flywheel fault condition comprises determining when the temperature exceeds an upper temperature limit.

18. The method of claim 13, in which the flywheel parameter comprises a pressure inside the flywheel housing, and in which determining the flywheel fault condition comprises determining when the pressure exceeds an upper pressure limit.

19. The method of claim 13, in which the machine further includes a clutch configured to selectively transmit torque between the flywheel and the ground engaging member, the clutch being movable between an engaged position, in which the flywheel is rotatably coupled to the ground engaging member, and a disengaged position, in which the flywheel is decoupled from the ground engaging member, the method further comprising actuating the clutch to the engaged position in response to the flywheel fault condition.

20. A method of performing flywheel diagnostics on a machine having an engine and a ground engaging member, the method comprising:
providing a flywheel assembly having a flywheel housing and an energy storage flywheel rotationally mounted in the flywheel housing;
providing a clutch configured to selectively transmit torque between the flywheel and the ground engaging member, the clutch being movable between an engaged position, in which the flywheel is rotatably coupled to the ground engaging member, and a disengaged position, in which the flywheel is decoupled from the ground engaging member;
determining an expected flywheel rotational speed;
determining an observed flywheel rotational speed;
determining a flywheel fault condition when the observed flywheel rotational speed exceeds the expected flywheel rotational speed; and
actuating the clutch to the disengaged position in response to the flywheel fault condition.
